(19) United States
(12) Patent Application Publication
(10) Pub. No.: US 2023/0390139 A1
(43) Pub. Date: Dec. 7, 2023

(54) Table Mounted Blood Circulation Enhancement Apparatus

(71) Applicant: Matthew James Humiston, Redondo Beach, CA (US)

(72) Inventor: Matthew James Humiston, Redondo Beach, CA (US)

(21) Appl. No.: 18/221,755

(22) Filed: Jul. 13, 2023

Related U.S. Application Data
(63) Continuation-in-part of application No. 17/546,233, filed on Dec. 9, 2021.

(51) Int. Cl. A61H 1/02

(52) U.S. Cl. CPC A61H 1/0229; A61H 2209/00; A61H 2201/0173; A61H 2201/0138

(57) ABSTRACT

This invention pertains to therapeutic or medical devices to improve healing, performance, or aesthetics by enhancing blood circulation to regions of the body. Blood circulation is enhanced using gravity by gradually raising and lowering the body member slowly and repeatedly from a level below the heart to a level above the heart.

Recovery from injuries can be a slow and time consuming process, requiring many hours over many days for the injury to heal. After recovery, ongoing treatment may be recommended to improve the overall health of the body part. Therefore, in order to be convenient and non-invasive, the therapeutic or medical device must not be too cumbersome or too invasive to be practical for regular use in a patient's home environment. The more cumbersome and/or invasive the device, the less likely the device will be employed and the less effective it will be in treating an injury.

This invention pertains to a blood circulation enhancement apparatus designed to be contained within a table, such as a living room coffee table, in order to provide convenience, ease-of-use, lateral stability, safety, quietness, and an unobtrusive and noninvasive storage location.

### BACKGROUND OF THE INVENTION

This invention relates to an apparatus to enhance blood circulation to a region of the body for the purpose of healing, improved performance, or aesthetic improvement.

Blood flow can be enhanced by repeatedly raising and lowering a body member from an elevation above the heart to an elevation below the heart very slowly to allow the blood time to move between regions of the body. Treatment by this method is a slow process that can take weeks if not months to treat an injury. Even after an injury is healed, patients may choose to continue use of the apparatus in order to prevent future injuries or to treat less serious conditions associated with poor blood circulation. Therefore, it is crucial that the apparatus is suitable for a patient's home environment. The apparatus must be safe in order to prevent injury to animals and other members of the household. The apparatus must also be quiet, comfortable, sanitary, and not too intrusive so as too discourage regular use.

Comfort is the most over-riding concern since many patients are in poor physical condition and often over-weight making physical movements painful. In order for the treatment to be successful, the patient must use the apparatus for at least one hour a day for several weeks or even months. Therefore, the comfort level is extremely important for the treatment to be successful.

### BRIEF SUMMARY OF THE INVENTION

A blood flow enhancement apparatus was developed to integrate into household furniture, such as a typical living room table. The wide base of a table provides the stability required to lift a heavy limb to a height well above the heart while providing the lateral strength to prevent injury due to instability of the apparatus. In addition, the table allows the apparatus to be stored in the location in which it will be used, eliminating the effort required to move the apparatus into position. The table also provides a barrier for protection from injury to other humans and pets along with noise reduction.

To help maximize usage by the patient, the sling was designed to for optimum comfort, weight distribution, ease-of-use, and cleanliness.

### DESCRIPTION

The apparatus consists of a supporting sling suspended by a motorized scissor lift. The scissor lift mechanism is contained within the structure of the table.

The sling may be elongated in order to spread the weight of the limb over a large support area. The sling material may be a stretchy fabric to conform to the shape of the patient's limb. The sling may pivot from a single point on each side to allow the support angle to change as the height of the sling changes. The supports for the sling may extend outward from the table towards the patient to spread the weight over a larger portion of the leg.

A safety barrier may be employed to surround the scissor lift mechanism to prevent injury to humans or animals.

### DRAWINGS

FIG. 1 is a side view of a preferred embodiment of the apparatus

FIG. 2 is a perspective view of a preferred embodiment of the apparatus integrated into a typical living room coffee table.

### DETAILED DESCRIPTION OF PREFERRED EMBODIMENT

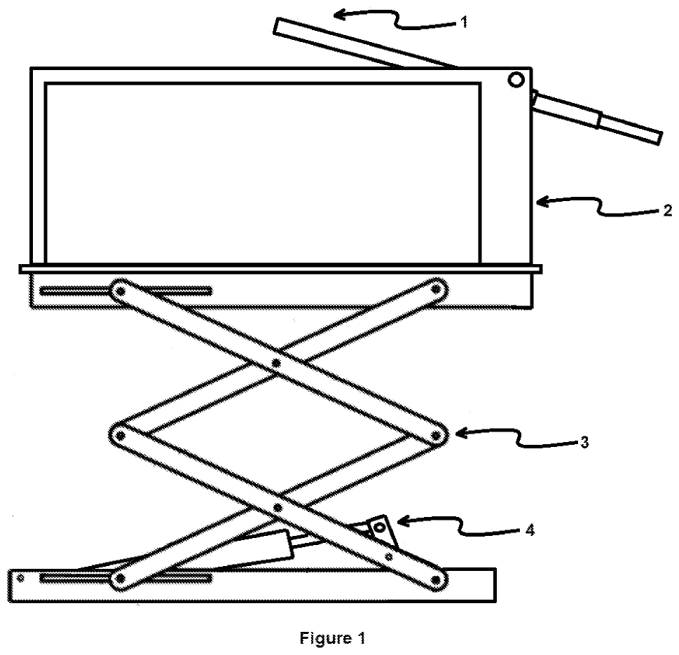

Turning to the drawings, there is illustrated in FIG. 1 an apparatus in accordance with the invention which comprises telescoping sling support rods 1, supported by a cradle 2. The cradle is affixed to the top of a motorized scissor lift assembly 3. The scissor lift assembly is actuated by a linear actuator 4 to provide the mechanical force to raise/lower the patient's limb in the cradle.

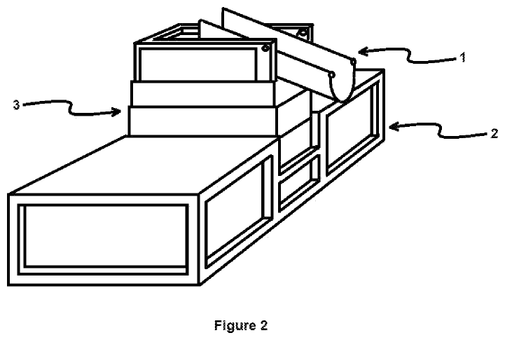

FIG. 2 provides an illustration of a Blood Circulation Enhancement Apparatus integrated into the design of a typical home living room coffee table 2. The drawing illustrates how the sling 1 extends in the direction towards the patient's body to support a greater portion of the patient's limb. Also illustrated in the drawing is the guarding material 3 surrounding the scissor lift to prevent injury or damage.

### REFERENCES CITED

### U.S. Patent Documents

| | | |
|---|---|---|
| 5207216 | October 5, 1992 | Sweeny |
| 20180255838 | November 2, 2017 | Suriff |
| 9108080 | August 18, 2015 | Cataldi/Hagen |
| 4546763 | October 18, 1985 | Coutts |
| 20180333328 | November 22, 2018 | Lurie |

### Classifications

### United States Classification: 600/16

### International Classification: A61H 100

1. An apparatus to repeatedly raise and lower a body member from an elevation above the heart to an elevation below the heart to enhance blood circulation in order to improve healing, performance, and aesthetics, in addition to other medical and health benefits.

2. An apparatus as in claim 1, comprising: a sling to support the body member; a lift apparatus to suspend the sling incorporated into a household table.
